(19) United States
(12) Patent Application Publication
(10) Pub. No.: US 2005/0003836 A1
(43) Pub. Date: Jan. 6, 2005

(54) Paging control apparatus, mobile node, paging control system, and paging control method

(75) Inventors: Masahiro Inoue, Yokosuka-shi (JP); Koji Omae, Yokohama-shi (JP); Ichiro Okajima, Yokohama-shi (JP); Narumi Umeda, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NTT DoCoMo, Inc., Tokyo (JP)

(21) Appl. No.: 10/859,983

(22) Filed: Jun. 4, 2004

(30) Foreign Application Priority Data
Jun. 4, 2003 (JP) 2003-160004

(51) Int. Cl. H04Q 7/20

(52) U.S. Cl. 455/458

(57) ABSTRACT

A paging agent 30 according to the present invention receives a paging request packet from a mobile node, and then determines a paging area, in response to the packet. The paging agent 30 notifies the mobile node of the determined paging area and controls this paging area. When the paging agent 30 receives a data packet directed to the mobile node in a paging control mode, it holds the packet in a buffer 371 and starts forwarding the data packet thus held, as triggered by reception of a paging notification confirmation packet from the mobile node.

### BACKGROUND OF THE INVENTION

1. Field of the Invention

The present invention relates to a paging control apparatus, a mobile node, a paging control system, and a paging control method.

2. Related Background Art

In mobility management in a mobile communication system, a control node in a network designates a control zone, and a radio channel number or a radio channel code in accordance with a registered location of a mobile node. In this manner, the mobility management is closely linked to the location management and to the radio management control for ensuring connectivity.

The paging control technology handles mobile nodes in wide-ranging paging area units, thereby reducing a volume of signals concerning the location registration control and the radio management control. Namely, the paging control technology has an aspect of the mobility management in a broad sense and has been regarded as important as a means for implementing power saving in conjunction with intermittent reception technology by the mobile nodes. Such paging control technology is built by a control interface peculiarly defined for each individual system and is implemented by letting the control node in the network carry out management of paging states and paging areas.

On the other hand, extension techniques of Mobile IP (Internet Protocol) v4 have been proposed as location registration control techniques in mobile communication systems using the fast and broadband radio access technology In such techniques, there exists a representative FA (Foreign Agent) among a plurality of FAs and the representative FA successively creates paging areas on the basis of subnet areas of FAs located under control thereof. The Seamoby working group of IETF (Internet Engineering Task Force) defines the IP paging to conduct paging control at the IP layer, and presents its problems and requirements.

As a technique of the same kind, there is a technique of carrying out the IP-level paging control on Mobile IPv4. This technique is one in which a paging server creates paging areas in units of addresses of FAs and in which each FA recognizes a paging area ID and broadcasts it to nodes in a unit area.

[Non-Patent Document 1]

RFC3132-“Dormant Mode Host Alerting (“IP Paging”) Problem Statement” and RFC3154-“Requirements and Functional. Architecture for an IP Host Alerting Protocol”

### SUMMARY OF THE INVENTION

However, the above-described conventional technologies are based on the specific mobile communication systems or Mobile IPv4, but are not adapted for the other systems or for the extension techniques of Mobile IPv4. For example, in the case of the mobility management control adapted for the extension techniques of Mobile IP (fast handoff, lossless handoff, etc.), the mobile node or the control node has to perform a new control procedure and transmission/reception of a control signal. There is also another problem that it is not sure whether a packet directed to a mobile node in paging can be forwarded without loss.

Furthermore, the above conventional technologies require a network operator to fixedly or variably set paging areas, which places a heavy burden on the operator and which increases setting restrictions despite the IP techniques essentially permitting flexible setting. There still remains a drawback that the setup of paging areas across a plurality of paging control devices involves complicated procedure among the control devices.

The present invention has been accomplished in view of the above problems and an object of the present invention is to implement appropriate paging control in accordance with a communication state and an operation state of a mobile node.

In order to achieve the above object, a paging control apparatus according to the present invention, which carries out management of paging states and paging areas in accordance with a state of a mobile node, comprises: receiving means for receiving a paging request packet transmitted from a mobile node; determining means for determining a paging area, in response to the paging request packet received by the receiving means; notifying means for notifying the mobile node of the paging area determined by the determining means; and controlling means for controlling the paging area determined by the determining means.

A paging control apparatus manages paging areas by home-address of the mobile node, an assortment of algorithm, a lifetime and an area-list. In the area-list, the network prefix, IP address of AR (Access Router) or AP (Anchor Point), AR address and the AP identifier (e.g. AR output port, MAC address) under this address are recorded. The variation of contents of the area-list is caused by the algorithm that forms the area.

A mobile node according to the present invention is a mobile node for performing transmission/reception of a packet to or from the paging control apparatus which carries out management of paging states and paging areas in accordance with a state of the mobile node, the mobile node comprising: setting means (corresponding to a timer described later) for setting a time from a start of a normal mode (an operation state according to MIP or an extended protocol thereof) to a transition into a paging control mode (an operation state according to IP paging); paging requesting means for transmitting a paging request packet to the paging control apparatus in accordance with passage of the time set by the setting means; and forwarding ordering means for transmitting to a mobility control apparatus a BU packet to order forwarding of a data packet to the paging control apparatus, in accordance with the passage of the time set by the setting means.

A paging control system according to the present invention comprises the paging control apparatus, which carries out management of paging states and paging areas in accordance with a state of a mobile node, comprising: receiving means for receiving a paging request packet transmitted from a mobile node; determining means for determining a paging area, in response to the paging request packet received by the receiving means; notifying means for notifying the mobile node of the paging area determined by the determining means; and controlling means for controlling the paging area determined by the determining means, and the mobile node for performing transmission/reception of a packet to or from the paging control apparatus which carries out management of paging states and paging areas in accordance with a state of the mobile node, the mobile node comprising: setting means for setting a time from a start of a normal mode to a transition into a paging control mode; paging requesting means for transmitting a paging request packet to the paging control apparatus, in accordance with passage of the time set by the setting means; and forwarding ordering means for transmitting to a mobility control apparatus a BU packet to order forwarding of a data packet to the paging control apparatus, in accordance with the passage of the time set by the setting means, wherein the paging control apparatus receives the paging request packet transmitted from the mobile node.

A paging control method according to the present invention is a paging control method comprising the following steps carried out by a mobile node capable of operating according to a plurality of mobility management protocols: a selecting step wherein the mobile node selects a mobility management protocol to be operated, based on a communication state and an operation state of the mobile node; and a communication step wherein the mobile node performs transmission/reception of a data packet based on the mobility management protocol selected in the selecting step.

The paging control method according to the present invention can further comprise a paging control step wherein the mobile node detects a data packet directed to said mobile node and change the plurality of mobility management protocols based on the detection result.

The above-described paging control method preferably further comprises a first transition step wherein when the mobile node detects no data packet directed to the mobile node, transmitted or received via the mobility control apparatus for a predetermined time, the mobile node halts a normal mode and makes a transition into a paging control mode.

The paging control method according to the present invention may further comprise a determining step wherein the mobile node determines the predetermined time as a trigger for the transition into the paging control mode in the first transition step, using at least an average continuation time of the paging control mode in the past or an average occurrence interval of handoff.

The above-described paging control method can further comprise a second transition step wherein when the mobile node in the paging control mode detects transmission/reception of a data packet directed to the mobile node, via the mobility control apparatus, the mobile node halts the paging control mode and again makes a transition into the normal mode.

The invention described above is directed to transmission/reception of a data packet addressed to the mobile node, via the paging control apparatus, and the present invention can also be applied to transmission/reception of a data packet addressed to the mobile node, via a communication partner node. In this case, the communication partner node has the function similar to that of the above paging control apparatus.

Namely, above-mentioned paging control method may further comprise a third transition step wherein when the mobile node does not detect transmission/reception of a data packet directed to said mobile node, via a communication partner node for a predetermined time, the mobile node halts a normal mode and makes a transition into a paging control mode.

The above-described paging control method may further comprise a fourth transition step wherein when the mobile node in the paging control mode detects transmission/reception of a data packet directed to the mobile node, via the communication partner node, the mobile node halts the paging control mode and again makes a transition into the normal mode.

According to these aspects of the invention, the mobile node monitors the communication state (a volume of packets transmitted or received, or the like) and the operation condition (a frequency of migrations or the like) of its own, and activates an appropriate mobility management protocol (e.g., IP paging) according to these states. For example, where the mobile node has a low volume of packets transmitted or received and a high migration frequency, the mobile node, together with the paging control apparatus or the communication partner node, determines a paging area. No path update is carried out on the occasion of migrations of the mobile node in this paging area and the mobility management except the IP paging is halted. Therefore, it becomes feasible to perform the appropriate paging control according to the communication state and the operation state of the mobile node, regardless of a type of a mobility management protocol used before a transition into the paging control mode (e.g., MIP or an extended protocol thereof)

More preferably, the paging control apparatus according to the present invention further comprises buffer controlling means for performing such a control as to make a buffer hold a data packet directed to the mobile node in a paging control mode.

More preferably, a paging control method according to the present invention is a paging control method comprising the following steps carried out by a paging control apparatus: a transmitting step wherein when the paging control apparatus detects a data packet directed to a mobile node having a paging area, the paging control apparatus transmits a paging notification packet directed to the mobile node, onto all forwarding paths in the paging area; a holding step wherein the paging control apparatus holds the data packet in a buffer until the paging control apparatus receives a paging notification confirmation packet from the mobile node; and a forwarding step wherein, after receiving the paging notification confirmation packet, the paging control apparatus forwards the data packet held in the holding step, to the mobile node through a forwarding path designated by the paging notification confirmation packet.

According to these aspects of the invention, a data packet transmitted from the mobility control apparatus to the mobile node is temporarily held (buffered) in the paging control apparatus and thereafter is forwarded through a predetermined path as triggered by reception of a paging notification confirmation packet from the mobile node. This substantializes secure transmission of packet without packet loss, even to the mobile node in paging.

The present invention enables execution of the appropriate paging control according to a communication state and an operation state of a mobile node.

The present invention will become more fully understood from the detailed description given herein below and the accompanying drawings which are given by way of illustration only, and thus are not to be considered as limiting the present-invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is an illustration showing an example of mobility management protocols at the IP layer.

FIG. 2 is an illustration showing a functional configuration of a paging agent.

FIG. 3 is an illustration for explaining a transition process into a paging control mode and a restoration process to a normal mode.

FIG. 4 is an illustration for explaining a paging area determining process in the paging control mode.

FIG. 5 is an illustration for explaining a paging area update process in the paging control mode.

FIG. 6 is an illustration for explaining a normal mode restoration process in the paging control mode.

FIG. 7 is a state transition diagram at a mobile node.

FIG. 8 is an illustration for explaining an aspect of performing paging control between a mobile node and communication partner nodes.

FIG. 9 is an illustration showing an example of paging header which is applicable to the present invention.

FIG. 10 is an illustration showing an example of paging message which is applicable to the present invention.

### DESCRIPTION OF THE PREFERRED EMBODIMENTS

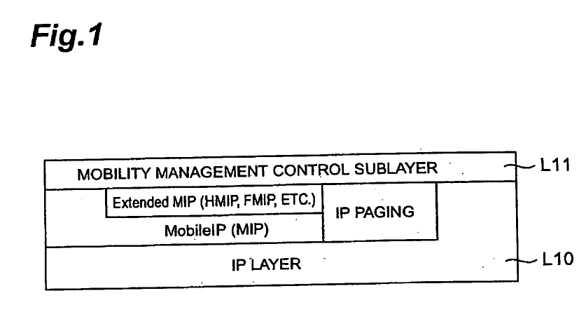

An embodiment of the present invention will be described below in detail with reference to the drawings. First, a structure of mobility management envisaged in the paging control apparatus according to the present invention will be described with reference to FIG. 1. As shown in FIG. 1, the IP paging exists as a broadly-defined mobility management protocol belonging to IP layer L10. The IP paging is a protocol existing alongside of Mobile IP (MIP), Extended MIP being an extended technology thereof, and so on. Examples of Extended MIP include Hierarchical Mobile IP (HMIP) and Fast Handover for Mobile IP (FMIP).

Selection of a protocol in the present embodiment means a choice of a protocol between Mobile IP or the extended technology thereof, and the IP paging In the present embodiment, an appropriate mobility management protocol is selected according to demands about permitted delay and packet loss, and the IP paging control is carried out depending upon the frequency of packet transmission/reception. Such protocol selection is carried out by mobility management control sublayer L11.

For example, where the mobile node operating in HMIP performs communication by an application severe about the permitted delay, the mobility management control sublayer L11 performs sessions by FMIP, depending upon application process monitoring or primitive issue. Conversely, it is also conceivable to adopt an implementation example in which when the mobility management control sublayer L11 determines that the number of retransmissions due to packet loss is large, the mobile node in operation by EMIP is made to operate by HMIP.

Subsequently, a configuration of a paging control system will be described. The paging control system is comprised of a mobile node (MN: Mobile Node 10), access routers (AR: Access Routers 21, 22), a paging agent (PA: Paging Agent 30), and a mobility agent (MA: Mobility Agent 40). The paging agent corresponds to the paging control apparatus as described in the scope of claims, and the mobility agent to the mobility control apparatus.

MN 10 has at least two operation states including a normal mode and a paging control mode. In the normal mode, MN 10 performs the operation of mobility management based on MIP or its extended technology implemented, and in the paging control mode MN 10 halts this operation and MN 10 is devoted to reception of packet and determines whether MN 10 is present in a paging area.

ARs 21, 22 are installed in their respective subnetworks different from each other, and transmit an RA (Router Advertisement) to MN 10 connected through a radio link.

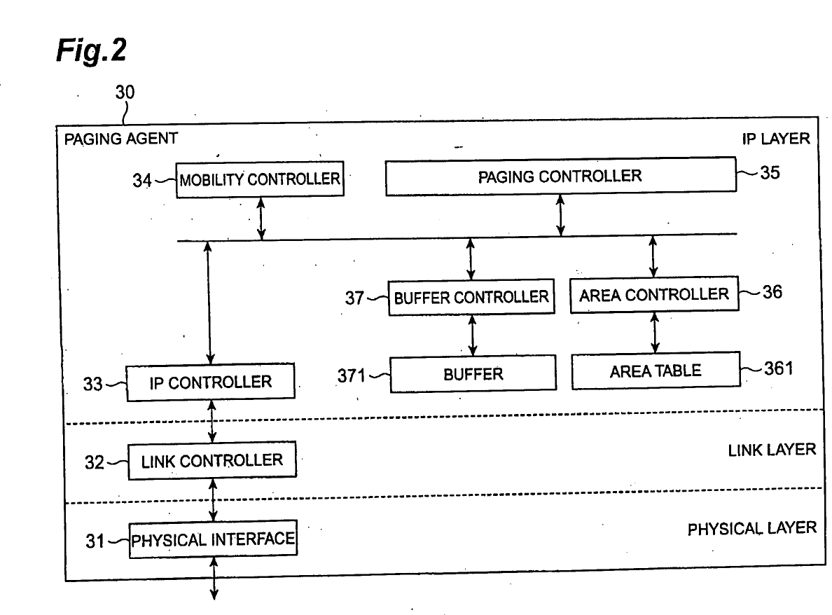

PA 30 creates a packet forwarding area and holds the area as a paging area. The paging area and an algorithm to determine this paging area are different in accordance with a communication state and an operation state of a mobile node. When PA 30 receives a data packet directed to MN 10 in paging control, it buffers the packet to hold it, and transmits a paging packet. FIG. 2 is an illustration showing a functional configuration of PA 30. As shown in FIG. 2, PA 30 has as well-known constituent elements, a physical interface 31 to operate at the physical layer, a link controller 32 to operate at the link layer, an IP controller 33 to operate at the IP layer, and a mobility controller 34.

Furthermore, PA 30 has a paging controller 35, an area controller 36, and a buffer controller 37 as constituent elements unique to the present invention. The paging controller 35 handles a paging control packet at the same layer as MIP. The area controller 36 creates a paging area with MN 10, thereafter notifies MN 10 of it, and holds the paging area information in an area table 361. The data held in the area table 361 is one or plural sub-network prefix that set for each home-address of MN 10. The buffer controller 37 performs such a control as to make a buffer 371 hold a data packet directed to MN 10 in paging control. An expiration date is set according to need for these paging area information and data packet, and data over the expiration date is erased according to instructions from the corresponding controller 36 or 37.

MA 40 is a node pursuant to a mobility management protocol such as MIP, HMIP, or FMIP, and, specifically, it corresponds to an HA (Home Agent), MAP (Mobile Anchor Point), FA (Foreign Agent), or the like.

Next, the operation of the paging control system will be described.

MN 10 detects a change of the subnet from a change of the network prefix value of RA in accordance with the mobility management control in the normal mode. MN 10 transmits a binding update packet (BU: Binding Update) to a corresponding mobility agent (e.g., MA 40) to carry out a path change process.

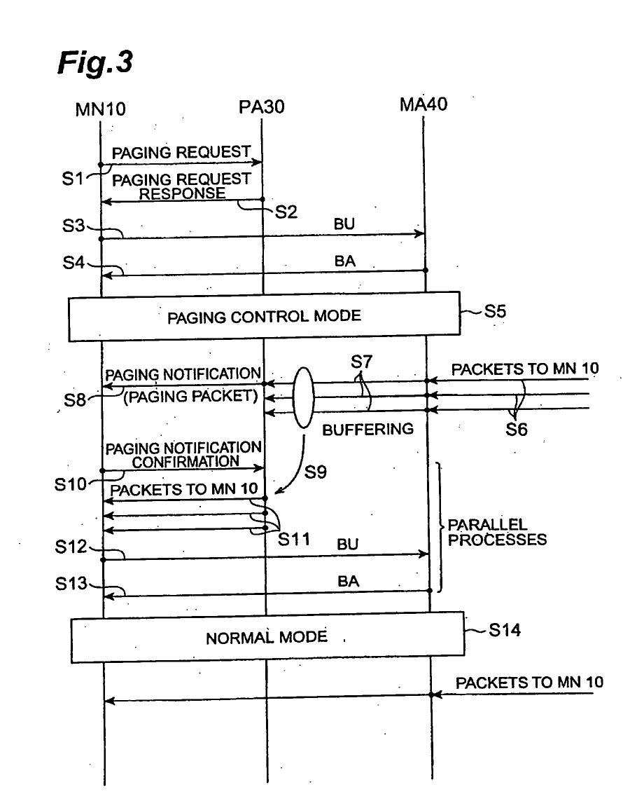

FIG. 3 is an illustration for explaining a transition process into the paging control mode and a restoration process to the normal mode. In FIG. 3, processing at AR to mediate communication between MN 10 and PA 30 is omitted for simplicity.

First, when determining that there is no data packet to be transmitted or received via MA 40, MN 10 transmits a paging request packet to PA 30 (S1).

When PA 30 permits the paging request from MN 10, it returns a paging request response packet accompanied by paging area information, to MN 10 (S2).

At the same time as the process of S1, MN 10 transmits a BU to make MA 40 forward a packet to PA 30, to MA 40 (S3).

MA 40 sends a BA (Binding Acknowledge) being an affirmative response to the BU, back to MN 10, and MN 10 receives it (54). This causes MN 10 to make a transition into the paging control mode (S5).

Data packets directed to MN 10 in the paging control mode are temporarily held in a binding cache of MA 40 (S6), and thereafter they are forwarded to PA 30 (S7). Receiving the data packets, PA 30 transmits a packet (paging packet) for notifying MN 10 of the arrival of data packets, toward the subnet of the paging area (S8). This results in sending the paging packet onto all forwarding paths in the above paging area. At the same time, PA 30 holds to buffer the data packets to MN 10 as successively forwarded (S9).

When MN 10 in the paging control detects the paging packet directed to itself, it returns a paging notification confirmation packet to PA 30 (S10). When receiving the paging notification confirmation packet from MN 10 in the paging control mode, PA 30 starts forwarding the data packets to MN 10 as buffered, via a predetermined forwarding path (S11). This permits the data packets to be delivered without loss, even to MN 10 in paging.

In parallel to the processes of S10 and S11, MN 10 also sends a BU to notify MA 40 of an address in the subnet where MN 10 is currently present, to MA 40 (S12). MA 40 sends a BA being an affirmative response to the BU, back to MN 10, and MN 10 receives it (S13). This causes MN 10 to be restored from the paging control mode to the normal mode (Si4).

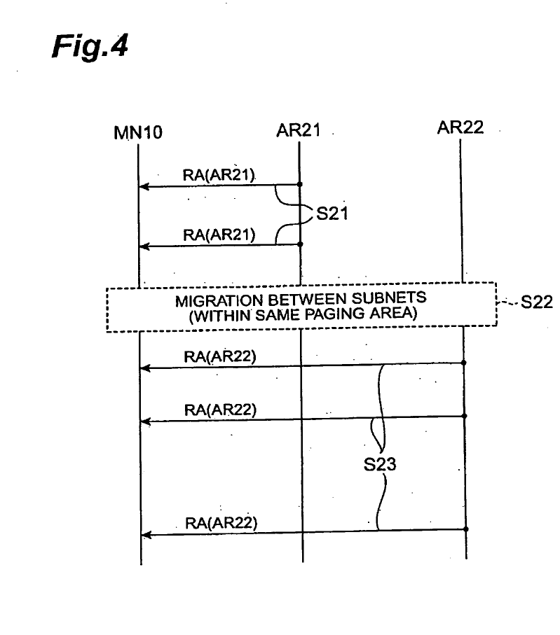

FIG. 4 is an illustration for explaining an area determining process in the paging control mode. MN 10 in the paging control performs determination of the paging area with reference to RA. Specifically, when MN 10, receiving RAs from AR 21 at S21, moves between different subnets in the same paging area (S22), it comes to receive RAs from AR 22 (S23). Since this causes a change of the network prefix value in RAs, MN 10 can detect a migration of itself between subnets. At this time, MN 10 in the paging control generates a c/o address (CoA: Care of Address) inside MN 10. However, MN 10 continuously stays in the paging control mode, without transmitting any packet to the other nodes including routers, different from the normal mode.

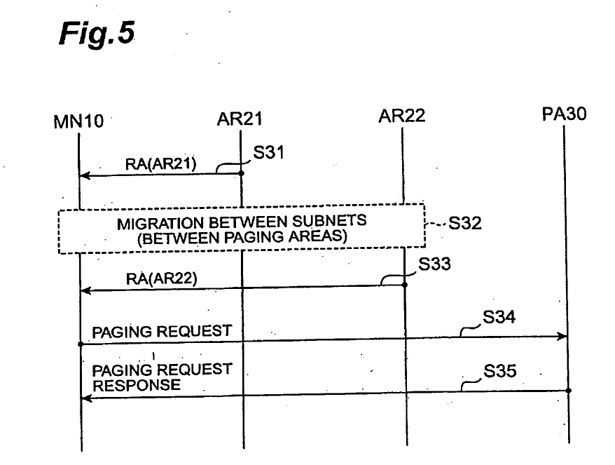

FIG. 5 is an illustration for explaining an area update process in the paging control mode. MN 10 in the paging control performs an update of the paging area with reference to RA. Specifically, when MN 10, receiving an RA from AR 21 at S31, moves between subnets in different paging areas (S32), it comes to receive an RA from AR 22 (S33). Since it causes a change of the paging area indicated by the network prefix value in RA, MN 10 can detect the migration between paging areas.

When MN 10 determines that it has moved out of a paging area, it transmits a paging request packet to PA 30 (S34). Then MN 10 receives a paging request response packet from PA 30 (S35), and thereafter MN 10 creates a new paging area, and continuously stays in the previous paging control mode. This completes re-registration of paging between MN 10 and PA 30.

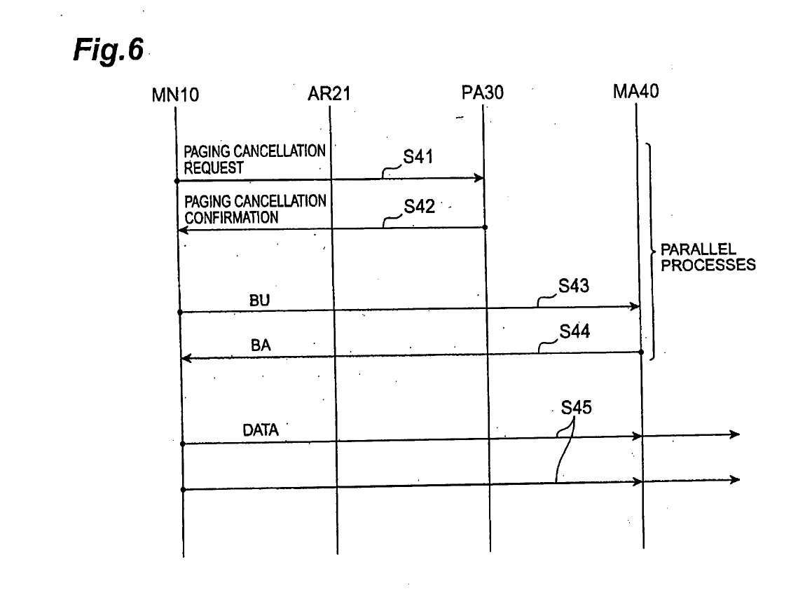

Furthermore, FIG. 6 is an illustration for explaining a restoration process from the paging control mode to the normal mode. When MN 10 in the paging control generates data packets to be transmitted via MA 40 by itself, it starts the restoration process to the normal mode. MN 10 sets a retention time of a paging registration cache to a sufficiently short time within a range where there occurs no state mismatch, and transmits a paging cancellation request packet to PA 30 (S41). This cancels the registration of the paging control mode of MN 10, at PA 30. At S42, PA 30 sends a paging cancellation confirmation packet back and MN 10 receives it.

In parallel to the processes of S41 and 542, MN 10 transmits a BU to establish a packet forwarding path, to MA 40 (S43), thereby registering the address in the subnet where MN 10 is present, at MA 40. At S44, MA 40 sends a BA back and MN 10 receives it. By this processing, MN 10 is restored to the normal mode and MN 10 starts transmitting the data packets according to a mobility management protocol implemented (S45).

Since PA 30 has no fixed management area as described above, it can reduce the burden of maintenance on the network operator.

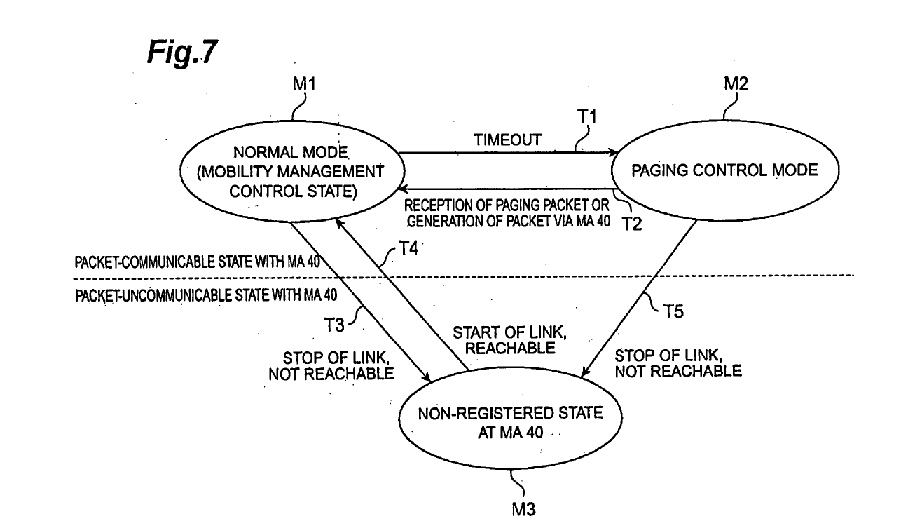

Transitions of MN 10 between modes will be described below with reference to FIG. 7. The scheme is based on the assumption that MN 10 has a packet-communicable state and an incommunicable state with MA 40. The communicable state refers to a state in which the setting of packet forwarding of MN 10 is active at MA 40. More specifically, it is a state in which a binding cache is retained. In contrast to it, the incommunicable state is a state in which the setting of packet forwarding of MN 10 is inactive, i.e., a state in which MN 10 is not registered at MA 40.

As shown in FIG. 7, the communicable state further comprises a normal mode M1 and a paging control mode M2. A transition from the normal mode M1 into the paging control mode M2 (T1) occurs as triggered by an event in which transmission/reception of data packet via MA 40 is not detected for a time interval predetermined by a timer of MN 10 (a timeout). On the other hand MN 10 once having moved into the paging control mode M2 is restored to the normal mode M1 as triggered by either reception of a paging packet from PA 30 or generation of a packet via MA 40 (T2).

When the number of control packets associated with the paging control satisfies conditional expression (1) below, we can expect reduction in the total number of control packets. This is because the total number of BU packets at a halt during the paging control becomes larger than the number of packets in the paging control at MN 10.
Tₚ≧Sₚ/(S_{b}−(TₐSₐ)/Tₐ)·Tₛ (1)

In the above expression, the symbols are defined as follows:
Tₚ: average continuation time of the paging control mode,
Sₚ: the number of control packets involved in the paging control,
S_{b}: the number of path update packets necessary for mobility management control in the normal mode,
Tₛ: average occurrence interval of migration between subnets,
Tₐ: average time to migration out of a paging area,
Sₐ: the number of re-registration packets in conjunction with migration between paging areas.

The time and the number of packets as parameters of above-referenced expression (1) are managed by the paging controller 35. The setting time of the timer used in the transition into the paging control mode M2 is preferably controlled as follows. For example, where the continuation times of the paging control mode M2 in the most recent several transitions do not satisfy the above expression (1), the setting time is lengthened to decrease the frequency of transitions into the paging control mode M2. A time interval without transmission/reception of packet via MA 40 is measured in the normal mode M1 and this time interval is regarded as Tₚ. When this results in satisfying the above expression (1), the setting time of the timer is shortened to increase the frequency of transitions into the paging control mode M2.

Three ways are specifically given as the way that lengthens or shortens the setting time of the timer.
e.g. 1) Long time and short time of the timer are set in advance.
e.g. 2) In case the following expression (I) consists, a fixed rate (1/10) of Tₚ is set to the short time of the timer, and in case the following expression (I) not consist, a fixed rate (10 times) of Tₚ is set to the long time of the timer.
e.g. 3) Paging control mode transition probability P_{rob} is defined as P_{rob} (Dₙₜ≧t) that a paging mode state or a non-communication state is maintained for time t. It is assumed that this probability is based on exponential distribution or gamma distribution and paging mode transition timer is determined. In case the following expression (I) consists, P_{rob} is set to a large value, and in case the following expression (I) not consist, P_{rob} is set to a small value.

$$Prob ( Dmt \geq t ) = 1 - {\int }_{0}^{t} \frac{1}{{b}^{c} \cdot Γ ( c )} {x}^{c - 1} exp ( - \frac{x}{b} ) ⅆ x \qquad ( I )$$

In the above expression (I), a term in the integral symbol is a probability density function of gamma distribution.

An average of the continuation times of the paging mode is equal to c*b.

“t” which gives above probability is calculated by Newton-Way and “t” is used as paging mode transition timer Td.

In that case, setting values further required are “c”, and a parameter (e.g. tolerance, the number of maximum repeat times) for Newton-Way.

According to gamma distribution and Newton-Way, it is possible that exponential distribution consists in case of “c=1”, besides, it is good for imitation of occurrence interval of plural applications.

In the same way, when “t” counted backward from P_{rob} (Dₙₜ≧t) is T_{d} (average value=b), following expressions (II), (III) consist.

$$\begin{matrix}Prob ( Dmt \geq t ) = exp ( - \frac{t}{b} ) & ( II ) \\ Td ( Prob ) = - b \cdot ln Prob ( Dmt \geq t ) & ( III )\end{matrix}$$

Since exponential distribution is used, calculation is simplified.

The aspect described in the above embodiment is just a preferred example of the paging control system according to the present invention, and the present invention is not limited to such aspect.

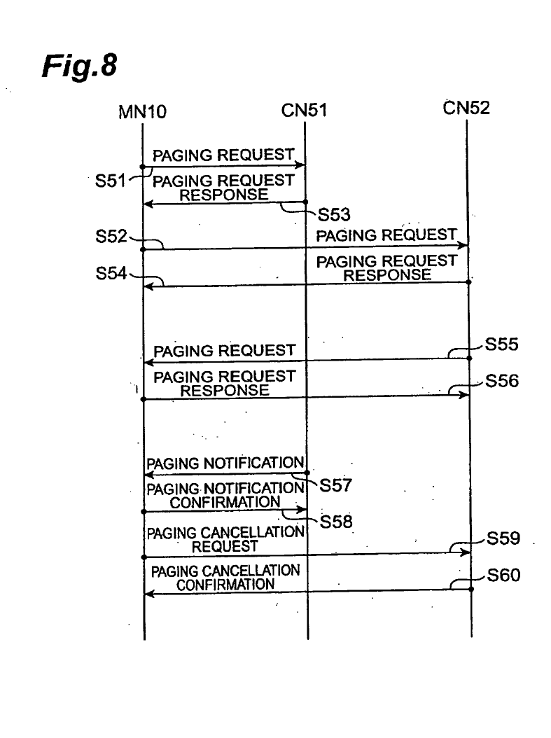

An aspect in which MN 10 directly executes the paging control with CNs (Correspondent Nodes) 51, 52 as communication partner nodes will be described below with reference to FIG. 8. The present aspect is similar to the aforementioned paging control technology described with FIGS. 2 to 7, expect that CNs 51, 52 instead of PA 30 are used as paging control apparatus. Therefore, the detailed description of this aspect will be omitted, but MN 10 and CNs 51, 52 perform transmission/reception of packet without passage via MA 40, in order to accomplish optimization of path.

At a time of a transition into the paging control mode, MN 10 transmits a paging request packet to each of CN 51 and CN 52 described in the cache of MN 10 (s51, S52). At this time, MN 10 sets paging control information including a paging area, an intermittent reception period for power saving control, and so on. Thereafter, MN 10 receives paging request response packets sent back from the respective CNs 51, 52 (S53, S54). The transition into the paging control mode can also be carried out independently for each of the communication partner nodes (CN 51, CN 52).

Subsequently, after CN 52 makes a transition into the paging control mode, it transmits a paging request packet to MN 10 as a communication partner (S55). Since at this point MN 10 is also in the paging control mode, the paging request packet may be directly broadcast in the paging area, or a paging notification packet may be transmitted to MN 10 to once restore MN 10 to the normal mode. At S56, MN 10 transmits a paging request response packet to CN 52.

Furthermore, when a packet directed to MN 10 is generated at CN 51, CN 51 transmits a paging notification packet to MN 10, in order to page MN 10 (S57). MN 10 sends back a paging notification confirmation packet (S58).

MN 10 is restored to the mobility management control state being the normal mode and also sends a paging cancellation request packet to CN 52, in order to notify CN 52 of the change of the mode (S59). CN 52 sends a paging cancellation confirmation packet back (S60).

In the packet control system of the present embodiment, as described above, MN 10 always monitors the communication state such as the volume of packets transmitted or received and the operation state such as the migration frequency, and selects and activates an appropriate mobility management protocol according to change of these states. Particularly, in a case where the mobility management protocol is a protocol associated with the IP paging, the system appropriately implements the notification of initiation of paging to MN 10 and the control of the paging area (paging control). This permits MN 10, even in paging, to securely receive a data packet directed to itself, regardless of the transition between subnets or regardless of the transition between paging areas.

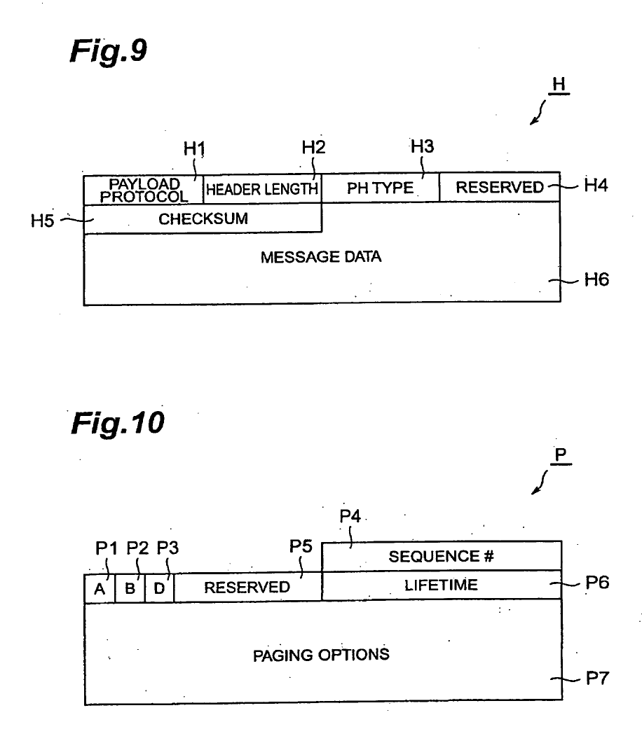

A Packet Format that is applicable to the above-mentioned embodiment will be exemplified below. The Packet Format is well-known technique in IPPv6, therefore won't be explained in detail but will be explained briefly. FIG. 9 is an illustration showing an example of paging header which is applicable to the present invention. In FIG. 9, Payload Protocol field H1 is a 8-bit field to discriminate a head part of the paging header and is also used to discriminate a protocol type. Header Length field H2 is a 8-bit field which shows data length of the paging header. PH type field H3 is a 8-bit field to discriminate a type of the paging header. Reserved field H4 is a data field that will be used for extension in future. Checksum field H5 is a 16-bit field to detect errors when the paging header is transmitted. And Message Data field H6 is a variable length field in which the above-described PH type data is stored.

Corresponding to the above paging header, DMR (Dormant Mode Request message), DMA (Dormant Mode Acknowledgement message), AMR (Active Mode Request message), AMA (Active Mode Acknowledgement message), and PR (Paging Request) are used for paging messages.

A Format of DMR will be representatively exemplified below as an example of paging message format. FIG. 10 is an illustration showing an example of the DMR. In FIG. 10, Acknowledge (A) field P1 is a field to require DMA to return to receipt of the DMR. Buffering (B) field P2 is a field to request a PA to store packets destined to a MN until the receipt of the AMR. Duplicate Address Detection (D) field P3 is a field to request a PA to detect duplicate address for Paging CoA. Sequence# field P4 is a 16-bit field to be used for matching a returned DMA with a sequence DMR. Reserved field P5 is a data field that will be used for extension in future. Lifetime field P6 is a 16-bit field in which the number of time units remaining before the binding is held. And Paging Options field P7 is a variable-length optional field in which zero or more TLV-encoded is stored.

The present invention is not limited to the above embodiments, but can also be suitably modified in various modification forms within the scope not departing from the spirit thereof. For example, the above embodiment exemplified the IP layer as a layer for the paging control, but the technology according to the present invention is not limited only to this example, but can also be applied to the transport layer (UDP (User Datagram Protocol) layer, TCP (Transmission Control Protocol) layer, etc.) and the application layer.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

1. A paging control apparatus, which carries out management of paging states and paging areas in accordance with a state of a mobile node, comprising:
receiving means for receiving a paging request packet transmitted from a mobile node;
determining means for determining a paging area, in response to the paging request packet received by the receiving means;
notifying means for notifying the mobile node of the paging area determined by the determining means; and
controlling means for controlling the paging area determined by the determining means.

2. The paging control apparatus according to claim 1, further comprising buffer controlling means for performing such a control as to make a buffer hold a data packet directed to the mobile node in a paging control mode.

3. A mobile node for performing transmission/reception of a packet to or from the paging control apparatus which carries out management of paging states and paging areas in accordance with a state of the mobile node, the mobile node comprising:
setting means for setting a time from a start of a normal mode to a transition into a paging control mode;
paging requesting means for transmitting a paging request packet to the paging control apparatus, in accordance with passage of the time set by the setting means; and
forwarding ordering means for transmitting to a mobility control apparatus a BU packet to order forwarding of a data packet to the paging control apparatus, in accordance with the passage of the time set by the setting means.

4. A paging control system comprising the paging control apparatus, which carries out management of paging states and paging areas in accordance with a state of a mobile node, comprising:
receiving means for receiving a paging request packet transmitted from a mobile node;
determining means for determining a paging area, in response to the paging request packet received by the receiving means;
notifying means for notifying the mobile node of the paging area determined by the determining means; and
controlling means for controlling the paging area determined by the determining means, and the mobile node for performing transmission/reception of a packet to or from the paging control apparatus which carries out management of paging states and paging areas in accordance with a state of the mobile node, the mobile node comprising:
setting means for setting a time from a start of a normal mode to a transition into a paging control mode;
paging requesting means for transmitting a paging request packet to the paging control apparatus, in accordance with passage of the time set by the setting means; and
forwarding ordering means for transmitting to a mobility control apparatus a BU packet to order forwarding of a data packet to the paging control apparatus, in accordance with the passage of the time set by the setting means,
wherein the paging control apparatus receives the paging request packet transmitted from the mobile node.

5. A paging control method comprising the following steps carried out by a mobile node capable of operating according to a plurality of mobility management protocols:
a selecting step wherein the mobile node selects a mobility management protocol to be operated, based on a communication state and an operation state of the mobile node; and
a communication step wherein the mobile node performs transmission/reception of a data packet based on the mobility management protocol selected in the selecting step.

6. A paging control method comprising the following steps carried out by a paging control apparatus:
a transmitting step wherein when the paging control apparatus detects a data packet directed to a mobile node having a paging area, the paging control apparatus transmits a paging notification packet directed to the mobile node, onto all forwarding paths in the paging area;
a holding step wherein the paging control apparatus holds the data packet in a buffer until the paging control apparatus receives a paging notification confirmation packet from the mobile node; and
a forwarding step wherein, after receiving the paging notification confirmation packet, the paging control apparatus forwards the data packet held in the holding step, to the mobile node through a forwarding path designated by the paging notification confirmation packet.

7. The paging control method according to claim 5, further comprising a first transition step wherein when the mobile node detects no data packet directed to said mobile node, transmitted or received via the mobility control apparatus for a predetermined time, the mobile node halts a normal mode and makes a transition into a paging control mode.

8. The paging control method according to claim 7, further comprising a determining step wherein the mobile node determines the predetermined time as a trigger for the transition into the paging control mode in the first transition step, using at least an average continuation time of the paging control mode in the past or an average occurrence interval of handoff.

9. The paging control method according to claim 7, further comprising a second transition step wherein when the mobile node in the paging control mode detects transmission/reception of a data packet directed to the mobile node, via the mobility control apparatus, the mobile node halts the paging control mode and again makes a transition into the normal mode.

10. The paging control method according to claim 5, further comprising a third transition step wherein when the mobile node does not detect transmission/reception of a data packet directed to said mobile node, via a communication partner node for a predetermined time, the mobile node halts a normal mode and makes a transition into a paging control mode.

11. The paging control method according to claim 10, further comprising a fourth transition step wherein when the mobile node in the paging control mode detects transmission/reception of a data packet directed to said mobile node, via the communication partner node, the mobile node halts the paging control mode and again makes a transition into the normal mode.

12. The paging control method according to claim 5, further comprising a paging control step wherein the mobile node detects a data packet directed to said mobile node and change the plurality of mobility management protocols based on the detection result.
